(19) United States
(12) Patent Application Publication
(10) Pub. No.: US 2015/0214511 A1
(43) Pub. Date: Jul. 30, 2015

(54) BATTERY PACK

(71) Applicant: Samsung SDI Co., Ltd., Yongin-si (KR)

(72) Inventor: Jae-Il Seong, Yongin-si (KR)

(21) Appl. No.: 14/516,081

(22) Filed: Oct. 16, 2014

(30) Foreign Application Priority Data
Jan. 28, 2014 (KR) 10-2014-0010879

(51) Int. Cl. H01M 2/02

(52) U.S. Cl. CPC H01M 2/0202; H01M 2002/0205; H01M 2220/30

(57) ABSTRACT

A battery which includes a can having an opening at one side thereof, an electrode assembly contained in the can, a cap plate closing the opening and including an electrode pin at an upper surface thereof and an anchor protruding outwards from a bottom surface thereof; and an insulating plate under the cap plate, wherein the cap plate includes a first side surface that is convex and a second side surface that is concave; the insulating plate has at a first end thereof an anchor opening combined with the anchor; and a width of the first end of the insulating plate is greater than a width of a second end of the insulating plate.

### CROSS-REFERENCE TO RELATED APPLICATION

This application claims priority to and the benefit of Korean Patent Application No. 10-2014-0010879, filed on Jan. 28, 2014, in the Korean Intellectual Property Office, the disclosure of which is incorporated herein in its entirety by reference.

### BACKGROUND

1. Field

One or more embodiments of the present invention relate to a curved battery pack.

2. Description of the Related Art

Unlike a primary battery that is not designed to be recharged, a secondary battery, which is a battery that can be repeatedly charged and discharged, is economically advantageous and environment-friendly, and thus, it is recommended to be used. The types of electronic devices in which secondary batteries are implemented have become diverse, and designs of the electronic devices have become an important factor used by consumers to determine which electronic devices to purchase.

For example, technology of various wearable computers using a secondary battery as their source of power and application examples thereof have been developed and published. Also, electronic devices, such as cellular phones and notebooks, have been designed to include a certain curved surface for an ergonomic design. Accordingly, to operate these electronic devices, it may be desirable to form the secondary battery to have a curved surface in accordance with the shapes of the electronic devices.

### SUMMARY

One or more embodiments of the present invention include a structure of a curved battery pack.

Additional aspects will be set forth in part in the description which follows and, in part, will be apparent from the description, or may be learned by practice of the presented embodiments.

According to one or more embodiments of the present invention, a battery pack includes a can having an opening at one side thereof, an electrode assembly in the can, a cap plate configured to close the opening and including an electrode pin at an upper surface thereof and an anchor protruding outwards from a bottom surface thereof, and an insulating plate under the cap plate, wherein the cap plate includes a first side surface that is convex and a second side surface that is concave; the insulating plate has at a first end thereof an anchor opening combined with the anchor; and a width of the first end of the insulating plate is greater than a width of a second end of the insulating plate.

The anchor opening may extend along a first direction, and a size of the anchor opening may be greater than a size of the anchor.

A distance between the anchor and the first side surface may be substantially the same as a distance between the anchor and the second side surface.

The first direction may be a direction from the anchor toward the first side surface.

The first and second side surfaces of the cap plate may have a substantially constant curvature, and the can may have substantially the same curvature as the cap plate.

The insulating plate may have a first side wall adjacent to the first side surface of the cap plate and a second side wall adjacent to the second side surface of the cap plate. The first side wall may be formed in a straight line, and the second side wall may be bent along the second side surface.

A portion of the first side wall of the insulating plate may be open.

The portion of the first side wall of the insulating plate is adjacent to the second end of the insulating plate.

The electrode pin may have a first polarity, and the cap plate may have a second polarity that is different from the first polarity.

The battery pack may further include a terminal plate under a bottom surface of the insulating plate.

The electrode assembly may include a first electrode plate having a first polarity, a second electrode plate having a second polarity that is different from the first polarity, and a separator between the first electrode plate and the second electrode plate. A side of the terminal plate may be electrically coupled to the second electrode plate and the other side of the terminal plate may be electrically coupled to the electrode pin.

The electrode pin may be electrically coupled to the other side of the terminal plate through the cap plate and the other side of the insulating plate.

According to one or more embodiments of the present invention, a battery pack includes a can having an opening at one side thereof; an electrode assembly configured to be in the can; a cap plate configured to close the opening and including an electrode pin at an upper portion thereof; an insulating plate under the cap plate; and a terminal plate under a bottom surface of the insulating plate, wherein the cap plate includes a first side surface and a second side surface having substantially the same curvature, and a width of a first end of the insulating plate is greater than a width of a second end of the insulating plate.

The first side surface of the cap plate may be closer to a curvature center than the second side surface of the cap plate. The insulating plate may further include a first side wall and a second side wall connecting the first end and the second end of the insulating plate and surrounding the terminal plate. The first side wall may be adjacent to the first side surface of the cap plate and the second side wall may be adjacent to the second side surface of the cap plate.

A corner portion in which the first end of the insulating plate and the first side wall meet each other may contact the first side surface of the cap plate, and the second side wall of the insulating plate may be spaced apart from the second side surface of the cap plate.

The cap plate may include an anchor in a bottom surface thereof, and the insulating plate may have at the end an anchor opening configured to align with the anchor portion and to fix the insulating plate.

A width of the insulating plate in a first direction may increase from the second end to the first end thereof, wherein the first direction may be a direction from the anchor toward the second side surface of the cap plate.

A size of the anchor opening may be greater than a size of the anchor.

The anchor opening may be formed to extend along the first direction, and the anchor may contact a side surface of the anchor opening, wherein the side surface of the anchor opening may be a portion that is most adjacent to the curvature center.

The terminal plate and the electrode pin may be electrically coupled to each other.

### BRIEF DESCRIPTION OF THE DRAWINGS

These and/or other features of embodiments of the present invention will become apparent and more readily appreciated from the following description of the embodiments, taken in conjunction with the accompanying drawings in which:

FIG. 1 is a perspective view schematically illustrating a battery pack according to an embodiment of the present invention;

FIG. 2 is an exploded perspective view schematically illustrating the battery pack of FIG. 1;

FIG. 3 is a bottom view schematically illustrating a cap assembly of FIG. 2; and

FIG. 4 is a front view schematically illustrating an insulating plate of FIG. 2.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

It will be understood that although the terms “first”, “second”, etc. may be used herein to describe various components, these components should not be limited by these terms. These components are only used to distinguish one component from another.

As used herein, the singular forms “a,” “an” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

It will be understood that when a layer, region, or component is referred to as being “formed on,” another layer, region, or component, it can be directly or indirectly formed on the other layer, region, or component. That is, for example, intervening layers, regions, or components may be present.

In the following examples, the x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

Sizes of elements in the drawings may be exaggerated for convenience of explanation. In other words, since sizes and thicknesses of components in the drawings are arbitrarily illustrated for convenience of explanation, the following embodiments are not limited thereto.

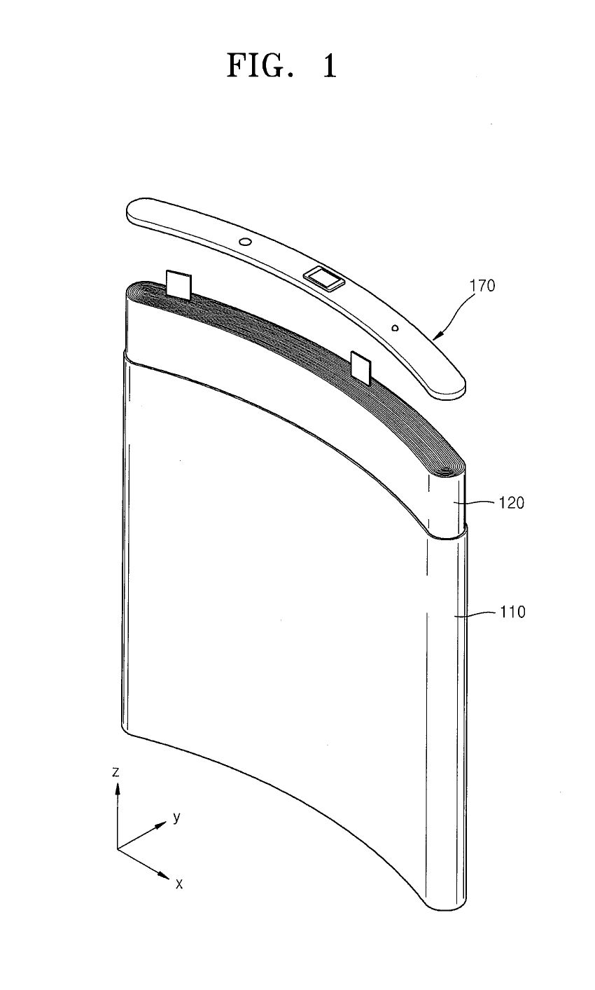

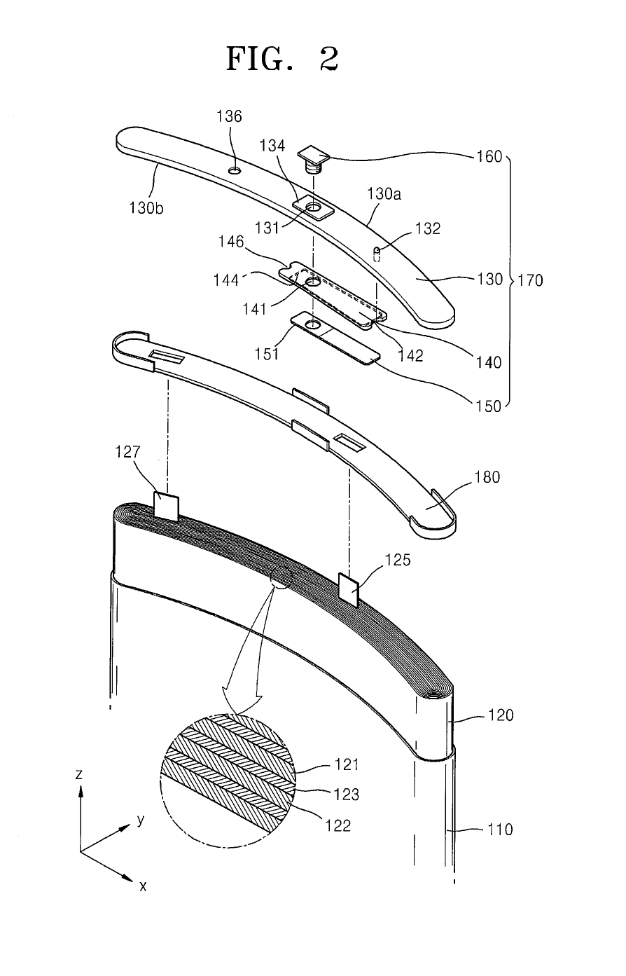

FIG. 1 is a perspective view schematically illustrating a battery pack according to an embodiment of the present invention, and FIG. 2 is an exploded perspective view schematically illustrating the battery pack of FIG. 1.

Referring to FIGS. 1 and 2, the battery pack may include a can 110 including an opening at one side thereof, an electrode assembly 120 configured to be in the can 110 and a cap assembly 170. The cap assembly 170 may include a cap plate 130 configured to close the opening of the can 110, an insulating plate 140, a terminal plate 150, and an electrode pin 160. The battery pack according to the present embodiment may include a lithium ion battery, which is a rechargeable secondary battery.

The can 110 has an upper end that is open and a shape that is flat and curved in one direction. The can 110 may be manufactured with a metal material to obtain rigidity. For example, the can 110 may be manufactured with aluminum (Al) or an Al alloy. After the electrode assembly 120 is inserted into the can 110 via the opening, the opening may be sealed by the cap plate 130. A contacting portion of the cap plate 130 and the can 110 is welded by laser so that inner air-tightness may be maintained.

The electrode assembly 120 may include a first electrode plate 121 and a second electrode plate 122, in which electrode active materials are spread, and a separator 123 interposed therebetween. The first electrode plate 121 and the second electrode plate 122 have different polarities. The electrode plate 120 may be manufactured by sequentially stacking the first electrode plate 121, the separator 123, and the second electrode plate 122 and winding the first electrode plate 121, the separator 123, and the second electrode plate 122 to be jelly-roll shaped. According to another embodiment of the present invention, the electrode assembly 120 may be a stack-type electrode assembly 120 in which the first electrode plate 121, the separator 123, and the second electrode plate 122 are sequentially stacked. However, for convenience of explanation, detailed descriptions will be made hereinafter, by assuming the electrode assembly 120 as the structure in which the first electrode plate 121, the second electrode plate 122, and the separator 123 are wound to have the jelly-roll shape.

The first electrode plate 121 may be any of a positive electrode film and a negative electrode film. When the first electrode plate 121 is a positive electrode film, the second electrode plate 122 may be a negative electrode film. On the contrary, when the first electrode plate 121 is a negative electrode film, the second electrode plate 122 may be a positive electrode film. In other words, the first electrode plate 121 and the second electrode plate 122 have different electrical polarities, and are not limited to have a specific polarity. However, for convenience of explanation, hereinafter, the case in which the first electrode plate 121 is a positive electrode film and the second electrode plate 122 is a negative electrode film will be described.

The first electrode plate 121 may include a first metal current collector (not shown) and a first active material portion (not shown) that is a portion in which a first active material (not shown) is spread on a surface of the first metal current collector. Likewise, the second electrode plate 122 may include a second metal current collector (not shown) and a second active material portion (not shown) that is a portion in which a second active material (not shown) is spread on a surface of the second metal current collector.

In the example embodiment in which the first electrode plate 121 is the positive electrode film, the first metal current collector may be a positive electrode current collector and the first active material portion may be a positive electrode active material portion. Also, in the example embodiment in which the second electrode plate 122 is the negative electrode film, the second metal current collector may be a negative electrode current collector and the second active material portion may be a negative electrode active material portion. As materials and structures of the positive electrode current collector, the positive electrode active material portion, the negative electrode current collector, and the negative electrode active material portion, materials and structures that are commonly known to one of ordinary skill in the art for general secondary batteries may be applied, and thus, their detailed descriptions will not be provided hereinafter.

The separator 123 may be may be a porous polymer membrane, such as polyethylene and polypropylene, or a shape of a woven or non-woven fabric including a polymer fiber. Alternatively, the separator 123 may include ceramic particles, or may be formed of a solid polyelectrolyte. The separator 123 may be an independent film, or may be a nonconductive porous layer on the first electrode plate 121 or the second electrode plate 122.

The separator 123 is electrically separate the first electrode plate 121 and the second electrode plate 122, and a shape of the separator 123 may not necessarily be the same as a shape of the first electrode plate 121 or the second electrode plate 122.

Electrode tabs may include a first electrode tab 127 and a second electrode tab 125 that are different from each other. The first and second electrode tabs 127 and 125 are provided so that the electrode assembly 120 is electrically connected with the outside. The first electrode tab 127 is electrically connected with the first electrode plate 121 and thus becomes a positive electrode, and the second electrode tab 125 is electrically connected with the second electrode plate 122 and thus becomes a negative electrode.

The cap plate 130 may be positioned on an upper surface of the can 110 to seal the opening of the can 110. The cap plate 130 may be manufactured with a metal material, such as Al or an Al alloy, similar to the can 110.

The cap plate 130 has a shape curved in a lengthwise direction, and may include a convex first side surface 130a and a concave second side surface 130b, arranged side by side. The first and second side surfaces 130a and 130b of the cap plate 130 may have similar (e.g., the same) curvature. The can 110 extends from the first side surface 130a and the second side surface 130b of the cap plate 130, and thus, the can 110 may have similar (e.g., the same) curvature as the cap plate 130. The first side surface 130a of the cap plate 130 has a convex shape and may be disposed relatively far (e.g., farther than the second side surface 130b) from a curvature center, and the second side surface 130b of the cap plate 130 has a concave shape and may be disposed relatively close (e.g., closer than the first side surface 130a) to the curvature center.

The electrode pin 160 may be located on the cap plate 130. The electrode pin 160 is inserted into terminal through-holes 131, 141, and 151 respectively in the cap plate 130, the insulating plate 140, and the terminal plate 150. The electrode pin 160 contacts the second electrode tab 125 of the electrode assembly 120 and is electrically connected with the first electrode plate 121, via the terminal plate 150. The electrode pin 160 is electrically insulated from the cap plate 130 via a gasket 134, when inserted into the terminal through-hole 131 of the cap plate 130.

The first electrode tab 127 may be electrically connected with the cap plate 130. The second electrode tab 125 may electrically contact the terminal plate 150 that will be described later, and, by this, may be electrically connected with the electrode pin 160. Since the first electrode tab 127 and the second electrode tab 125 have different polarities, the cap plate 130 and the electrode pin 160 that are respectively connected with the first electrode tab 127 and the second electrode tab 125 also have different polarities. For example, the cap plate 130 may have a positive polarity, and the electrode pin 160 may have a negative polarity.

To prevent a short circuit between the electrode pin 160 and the cap plate 130, the gasket 134 may be provided between the electrode pin 160 and the cap plate 130. The gasket 134 may be manufactured with an insulating material and prevents an electrical short circuit between the electrode pin 160 and the cap plate 130.

The terminal through-hole 131 is in the center of the cap plate 130. The electrode pin 160 is insulated by the gasket 134 and the electrode pin 160 may be electrically coupled to the terminal plate 150 via the terminal through-hole 131 of the cap plate 130.

An anchor portion 132 may be located at one side of the cap plate 130. The anchor portion 132 may protrude outwards from a bottom surface of the cap plate 130. The anchor portion 132 is combined with an anchor hole 142 in the insulating plate 140 and serves a function of fixing the insulating plate 140.

The insulating plate 140 may be positioned under the bottom surface of the cap plate 130 and may be of a similar (e.g., the same) insulating material as the gasket 134. The terminal through-hole 141, into which the electrode pin 160 is inserted, is in the insulating plate 140, in a location corresponding to a location of the terminal through-hole 131 of the cap plate 130. A safe-fixing groove 144, having a size corresponding to a size of the terminal plate 150, is in a bottom surface of the insulating plate 140 to safely fix the terminal plate 150. Aspects with respect to the insulating plate 140 will be described later in detail.

The terminal plate 150 may be a nickel (Ni) alloy and combined with the bottom surface of the insulating plate 140. The terminal through-hole 151, into which the electrode pin 160 is inserted, is in the terminal plate 150, in a location corresponding to the location of the terminal through-hole 131 of the cap plate 130. As the electrode pin 160 is insulated from the cap plate 130 by the gasket 134 and combined with the terminal plate 150 via the terminal through-hole 131 of the cap plate 130, the terminal plate 150 is electrically insulated from the cap plate 130 and electrically connected with the electrode pin 160.

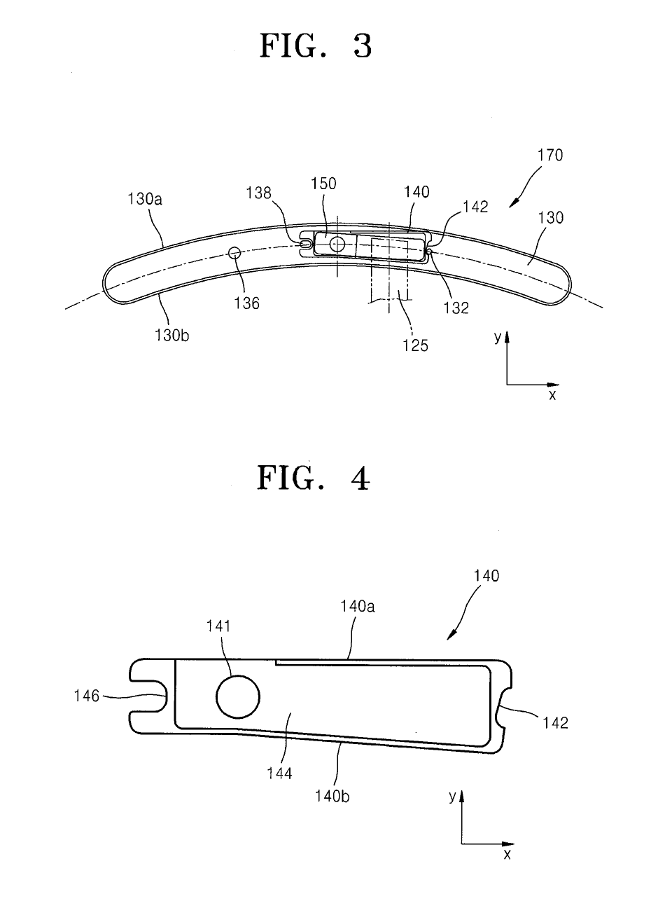

FIG. 3 is a bottom view schematically illustrating the cap assembly 170 of FIG. 2, and FIG. 4 is a front view schematically illustrating the insulating plate 140 of FIG. 2.

To describe in detail a structure of the cap assembly 170 by referring to FIG. 3, the cap assembly 170 includes the cap plate 130, the insulating plate 140, the terminal plate 150, and the electrode pin 160. The cap assembly 170 is combined with an additional insulating case 180 (shown in FIG. 2) and is combined with the opening of the can 110, thereby sealing the opening of the can 110.

The cap plate 130 includes the first and second side surfaces 130a and 130b arranged side by side and having similar (e.g., the same) curvature, and the electrode pin 160, the gasket 134, the terminal through-hole 131, the anchor portion 132, and an electrolyte inlet 136 that are disposed in an upper surface portion thereof.

The cap plate 130 is a metal plate having a size and a shape corresponding to a size and a shape of the opening of the can 110. The cap plate 130 includes the convex first side surface 130a and the concave second side surface 130b, arranged side by side so as to have a substantially constant curvature (e.g., a constant curvature) in a lengthwise direction.

The cap plate 130 has the shape that is curved in the lengthwise direction, and may include the convex first side surface 130a and the concave second side surface 130b, arranged side by side. The first side surface 130a and the second side surface 130b of the cap plate 130 may have similar (e.g., the same) curvature. Since the can 110 extends from the first side surface 130a and the second side surface 130b of the cap plate 130, the can 110 may have similar (e.g., the same) curvature as the cap plate 130. The first side surface 130a of the cap plate 130 has a convex shape and may be disposed relatively far (e.g., farther than the second side surface 130b) from a curvature center, and the second side surface 130b of the cap plate 130 has a concave shape and may be disposed relatively close (e.g., closer than the first side surface 130a) to the curvature center.

The electrode pin 160 may be located at the center of an upper surface of the cap plate 130. The electrode pin 160 is electrically connected with the terminal plate 150 through the terminal through-hole 131 of the cap plate 130, the terminal through-hole 141 of the insulating plate 140, and the terminal through-hole 151 of the terminal plate 150. As described above, the first electrode tab 127 may be electrically connected with the cap plate 130, and the second electrode tab 125 may be electrically connected with the terminal plate 150 that will be described later. By this, the second electrode tab 125 may be electrically connected with the electrode pin 160. Thus, the cap plate 130 may have a positive polarity and the electrode pin 160 may have a negative polarity.

The gasket 134 may be provided between the electrode pin 160 and the cap plate 130. The gasket 134 is manufactured with an insulating material and prevents a short circuit between the electrode pin 160 and the cap plate 130.

The terminal through-hole 131 having a size (e.g., a predetermined size) is in the center of the upper surface of the cap plate 130, and the electrode pin 160 is inserted and combined with the terminal through-hole 131. As described above, the gasket 134 is assembled in the terminal through-hole 131 to insulate the electrode pin 160 and the cap plate 130.

The anchor portion 132 is at one side of the cap plate 130 with the terminal through-hole 131 as the center. As described above, the anchor portion 132 may protrude outwards from the bottom surface of the cap plate 130. The anchor portion 132 is combined with the anchor hole 142 in the insulating plate 140 and serves a function of fixing the insulating plate 140.

The anchor portion 132 may be disposed in the center of the cap plate 130 in a width direction. That is, a distance between the anchor portion 132 and the first side surface 130a of the cap plate 130 may be similar to (e.g., the same as) a distance between the anchor portion 132 and the second side surface 130b of the cap plate 130. This means that even though a location of the anchor portion 132 may change according to a curved shape of the cap plate 130 as the battery pack is curved by pressure, the location of the anchor portion 132 in the cap plate 130 may still be the same. Thus, the anchor portion 132 contacts a side surface of the anchor hole 142, and the side surface of the anchor hole 142 may be a portion that is most adjacent to the curvature center. In other words, the anchor portion 132 contacts the side surface of the anchor hole 142, and the side surface of the anchor hole 142 may be a portion that is most adjacent to a second side wall 140b of the insulating plate 140.

The electrolyte inlet 136 is at the other side of the cap plate 130 with the terminal through-hole 131 as the center. An electrolyte may be injected into the can 110 that is sealed by the cap plate 130 via the electrolyte inlet 136. The electrolyte inlet 136 may be sealed by a sealing cap (not shown) after the injection of the electrolyte.

The insulating plate 140 may be in an approximately ladder shape, and may be of a similar (e.g., the same) insulating material as the gasket 134. A detailed structure of the insulating plate 140 will be described by referring to FIG. 4.

The insulating plate 140 may include a first side wall 140a and the second side wall 140b connecting an end and the other end of the insulating plate 140. Also, the insulating plate 140 may include the terminal through-hole 141, the anchor hole 142, the safe-fixing groove 144, and a combining U-shaped opening 146. The safe-fixing groove 144 may be at the other end of the insulating plate 140, and the anchor hole 142 may be at the end of the insulating plate 140.

As described above, the insulating plate 140 may include the first side wall 140a and the second side wall 140b connecting the end and the other end of the insulating plate 140 and surrounding the terminal plate 150. The first side wall 140a may be adjacent to the first side surface 130a of the cap plate 130, and the second side wall 140b may be adjacent to the second side surface 130b of the cap plate 130. In other words, the second side wall 140b may be located closer to the curvature center of the cap plate 130 than the first side wall 140a.

As illustrated in FIGS. 3 and 4, the first side wall 140a of the insulating plate 140 may have a shape of a straight line and the second side wall 140b may have a shape that is bent along the second side surface 130b of the cap plate 130. Thus, a corner portion in which the end of the insulating plate 140 and the straight-lined first side wall 140a meet each other may contact the first side surface 130a that is convex to have a substantially constant curvature (e.g., a constant curvature). On the contrary, as illustrated in FIG. 3, the second side wall 140b of the insulating plate 140 may be spaced apart from the second side surface 130b of the cap plate 130.

As described above, the first side wall 140a of the insulating plate 140 may have a shape of a straight line, and the second side wall 140b of the insulating plate 140 may have a shape that is bent along the second side surface 130b of the cap plate 130. Thus, the insulating plate 140 may have a shape where a width of the insulating plate 140 in a first direction (direction y) increases from the other end to the end thereof. Here, the first direction (direction y) may be understood to be a direction from the anchor portion 132 toward the second side surface 130b of the cap plate 130.

This means that because the terminal plate 150 may rotate with the terminal through-hole 151 as the center as the cap plate 130 is curved to have a substantially constant curvature (e.g., a constant curvature) by pressure in a process of manufacturing a curved battery pack, the width of the end of the insulating plate 140 is wider than the other end of the insulating plate 140 to comply with a rotation radius of an end of the terminal plate 150. Thus, by this, a problem, such as a contact defect, which may occur in a process of manufacturing the battery pack which is curved by pressure, may be solved.

The first side wall 140a of the insulating plate 140 may have an open portion of the first side wall 140a adjacent to the terminal through-hole 141. This means that because the terminal plate 150 may rotate with the terminal through-hole 151 as the center as the cap plate 130 is curved to have a substantially constant curvature (e.g., a constant curvature) in the process of manufacturing the curved battery pack, the portion of the first side wall 140a of the insulating plate 140, which is adjacent to the other end of the insulating plate 140, is removed in compliance with a rotation radius of the other end of the terminal plate 150. Accordingly, by this, a problem such as a contact defect, which may occur in the process of manufacturing the battery pack which is curved by pressure, may be solved.

The terminal through-hole 141 may be in a location corresponding to the terminal through-hole 131 of the cap plate 130 when the insulating plate 140 and the cap plate 130 are combined, and the electrode pin 160 may be inserted into the terminal through-hole 141.

The anchor hole 142 may be f at the end of the insulating plate 140, and, as illustrated in FIG. 3, may be in a location corresponding to the anchor portion 132 in the bottom surface of the cap plate 130. The anchor hole 142 of the insulating plate 140 is combined with the anchor portion 132 f in the bottom surface of the cap plate 130 so as to fix the terminal plate 150 to the cap plate 130.

As illustrated in FIG. 3, the anchor hole 142 may extend along the first direction (direction y), and the first direction (direction y) may be understood to denote the direction from the anchor portion 132 toward the second side surface 130b of the cap plate 130. Thus, the anchor hole 142 of the insulating plate 140 may be bigger than the anchor portion 132 of the cap plate 130. The reason that the anchor hole 142 is bigger than the anchor portion 132 is because a location to which the anchor portion 132 moves is considered, when the anchor portion 132 located at one side of the cap plate 130 also moves as the cap plate 130 is bent in shape in a process in which the battery pack is curved by pressure.

Accordingly, the anchor portion 132 may be located to contact a side surface of the anchor hole 142, and the side surface of the anchor hole 142 may be a portion that is most adjacent (e.g., closest) to a curvature center of the curved battery pack. Thus, before the battery pack is curved, the anchor portion 132 may be fixed to a portion that is most adjacent (e.g., closest) to the first side surface 130a of the cap plate 130, but after the battery pack is curved, the anchor portion 132 may be fixed to a portion that is most adjacent (e.g., closest) to the second side surface 130b.

The safe-fixing groove 144 is where the terminal plate 150 is located at, and may be at a bottom surface of the insulating plate 140 as a size corresponding to the terminal plate 150. A depth of the safe-fixing groove 144 may be less than a thickness of the terminal plate 150.

The combining U-shaped opening 146 may be at the other end of the insulating plate 140. The combining U-shaped opening 146 may be in a location corresponding to a combining tip 138 at the bottom surface of the cap plate 130, and the combining tip 138 of the cap plate 130 may be inserted into and combined with the combining U-shaped opening 146 of the insulating plate 140. When the combining U-shaped opening 146 of the insulating plate 140 and the combining tip 138 of the cap plate 130 are combined, the insulating plate 140 and the terminal plate 150 may be prevented from rotating with respect to the cap plate 130, in a process in which the electrode pin 160 is inserted into the terminal through-hole 151.

Referring to FIG. 3 again, the terminal plate 150 may be a Ni alloy and combined with a bottom surface of the insulating plate 140, as described above. One side of the terminal plate 150 may be electrically connected with the second electrode plate 122 via the second electrode tab 125, and the other side of the terminal plate 150 may be electrically connected with the electrode pin 160. By this, the second electrode plate 122 and the electrode pin 160 may be electrically connected.

The terminal through-hole 151, into which the electrode pin 160 is inserted, is in the terminal plate 150 in a location corresponding to the terminal through-hole 131 of the cap plate 130. As the electrode pin 160 is insulated from the cap plate 130 by the gasket 134 and combined with the terminal plate 150 via the terminal through-hole 131 of the cap plate 130, the terminal plate 150 is electrically insulated from the cap plate 130 and electrically connected with the electrode pin 160.

The terminal plate 150 may be a size corresponding to a size of the safe-fixing groove 144 of the insulating plate 140, and may be safely fixed to the safe-fixing groove 144 of the insulating plate 140.

Although the terminal plate 150 is positioned where the terminal plate 150 may be bent and thus contact the second side wall 140b of the insulating plate 140, in FIG. 3, it is not necessarily limited thereto. The terminal plate 150 may also be positioned to contact the first side wall 140a of the insulating plate 140. Only, as illustrated in FIG. 3, in a process in which the battery pack is curved by pressure, a side of the terminal plate 150, which is an opposite side to the other side of the terminal plate 150 fixed by the electrode pin 160, may move so that the terminal plate 150 contacts the second side wall 140b of the insulating plate 140.

Thus, in this case, the insulating plate 140 may have a shape where a portion of the first side wall 140a of the insulating plate, which is adjacent to the other end of the insulating plate 140, is removed in consideration of the location movement of the terminal plate 150. Therefore, by this, a problem, such as a contact defect, which may occur in the process of manufacturing the battery pack which is curved by pressure, may be solved.

As described above, according to the one or more of the above embodiments of the present invention, a battery pack that has a reduced rate of defect occurrence in the process of manufacturing the curved battery may be achieved.

It should be understood that the example embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims and their equivalents.

What is claimed is:

1. A battery pack comprising:
a can having an opening at one side thereof;
an electrode assembly in the can;
a cap plate closing the opening and comprising an electrode pin at an upper surface thereof and an anchor protruding outwards from a bottom surface thereof; and
an insulating plate under the cap plate,
wherein the cap plate comprises a first side surface that is convex and a second side surface that is concave;
the insulating plate has at a first end thereof an anchor opening combined with the anchor; and
a width of the first end of the insulating plate is greater than a width of a second end of the insulating plate.

2. The battery pack of claim 1, wherein the anchor opening extends along a first direction, and a size of the anchor opening is greater than a size of the anchor.

3. The battery pack of claim 2, wherein a distance between the anchor and the first side surface is substantially the same as a distance between the anchor and the second side surface.

4. The battery pack of claim 3, wherein the first direction is a direction from the anchor toward the first side surface.

5. The battery pack of claim 1, wherein the first and second side surfaces of the cap plate have a substantially constant curvature, and the can has substantially the same curvature as the cap plate.

6. The battery pack of claim 1, wherein the insulating plate has a first side wall adjacent to the first side surface of the cap plate and a second side wall adjacent to the second side surface of the cap plate, and wherein the first side wall is formed in a straight line and the second side wall is bent along the second side surface.

7. The battery pack of claim 6, wherein a portion of the first side wall of the insulating plate is open.

8. The battery pack of claim 7, wherein the portion of the first side wall of the insulating plate is adjacent to the second end of the insulating plate.

9. The battery pack of claim 1, wherein the electrode pin has a first polarity, and the cap plate has a second polarity that is different from the first polarity.

10. The battery pack of claim 1, further comprising a terminal plate under a bottom surface of the insulating plate.

11. The battery pack of claim 10, wherein the electrode assembly comprises a first electrode plate having a first polarity, a second electrode plate having a second polarity that is different from the first polarity, and a separator between the first electrode plate and the second electrode plate; and
a side of the terminal plate electrically coupled to the second electrode plate and the other side of the terminal plate electrically coupled to the electrode pin.

12. The battery pack of claim 11, wherein the electrode pin is electrically coupled to the other side of the terminal plate through the cap plate and the other side of the insulating plate.

13. A battery pack comprising:
a can having an opening at one side thereof;
an electrode assembly contained in the can;
a cap plate closing the opening and comprising an electrode pin at an upper portion thereof;
an insulating plate under the cap plate; and
a terminal plate under a bottom surface of the insulating plate,
wherein the cap plate comprises a first side surface and a second side surface having substantially the same curvature, and a width of a first end of the insulating plate is greater than a width of a second end of the insulating plate.

14. The battery pack of claim 13, wherein the first side surface of the cap plate is closer to a curvature center than the second side surface of the cap plate;
the insulating plate further comprises a first side wall and a second side wall connecting the first end and the second end of the insulating plate and surrounding the terminal plate; and
the first side wall is adjacent to the first side surface of the cap plate and the second side wall is adjacent to the second side surface of the cap plate.

15. The battery pack of claim 14, wherein a corner portion, in which the first end of the insulating plate and the first side wall meet each other, contacts the first side surface of the cap plate, and the second side wall of the insulating plate is spaced apart from the second side surface of the cap plate.

16. The battery pack of claim 15, wherein the cap plate comprises an anchor in a bottom surface thereof, and the insulating plate has at the end an anchor opening combined with the anchor and fixing the insulating plate.

17. The battery pack of claim 16, wherein a width of the insulating plate in a first direction increases from the second end to the first end thereof, wherein the first direction is a direction from the anchor toward the second side surface of the cap plate.

18. The battery pack of claim 17, wherein a size of the anchor opening is greater than a size of the anchor.

19. The battery pack of claim 18, wherein the anchor opening is formed to extend along the first direction, and the anchor contacts a side surface of the anchor opening, wherein the side surface of the anchor opening is a portion that is most adjacent to the curvature center.

20. The battery pack of claim 14, wherein the terminal plate and the electrode pin are electrically coupled to each other.
